(19) United States
(12) Patent Application Publication
(10) Pub. No.: US 2026/0240091 A1
(43) Pub. Date: Aug. 20, 2026

(54) IRRIGATION CONTROLLER INTERFACES AND ASSOCIATED SYSTEMS, DEVICES, AND METHODS

(71) Applicant: Telsco Industries, Inc. d/b/a Weathermatic, Garland, TX (US)

(72) Inventors: William C. Savelle, Osprey, FL (US); Michael Dean Rene, Ennis, TX (US); Michael Andrew McCafferty, Wylie, TX (US)

(21) Appl. No.: 19/537,788

(22) Filed: Feb. 12, 2026

Related U.S. Application Data
(60) Provisional application No. 63/758,418, filed on Feb. 14, 2025.

(51) Int. Cl. A01G 25/16; A01G 25/02

(52) U.S. Cl. CPC A01G 25/16; A01G 25/02

(57) ABSTRACT

Described herein are methods, systems, and devices for irrigation controller interfaces. An irrigation controller interface device may include a first communication interface configured to establish a first connection between the irrigation controller interface device and an irrigation controller; a second communication interface configured to transmit and receive signals from a cellular data modem; and one or more processors operatively connected to the first communication interface and second communication interface. The one or more processors may be configured to: receive an instruction from the cellular data modem via the second communication interface, wherein the instruction indicates one or more zones of an irrigation system to control; generate a control signal to control the one or more zones based on the instruction; and cause the control signal to be transmitted via the first communication interface to the irrigation controller.

### CROSS REFERENCE TO RELATED APPLICATIONS

This application claims the priority benefit under 35 U.S.C. §119(e) of U.S. Provisional Patent Application No. 63/758,418, filed 14 February 2025 and entitled “Irrigation Controller Interfaces and Associated Systems, Devices, and Methods,” which is hereby incorporated by reference in its entirety as though fully set forth herein.

### TECHNICAL FIELD

The present disclosure relates generally to irrigation water management and, more specifically, to irrigation controller interfaces and associated systems, devices, and methods.

### BACKGROUND

Irrigation systems are well-known, useful mechanisms for providing for the watering needs of turf, plants and other types of foliage above the amount that is naturally available from precipitation. In this increasingly urbanized world, a customized landscape of turf, ornamentals and meticulously placed trees can inspire the illusion of mood for residents, employees and even passersby to the property. The proper management of campus green space can not only increase the value of the property, but also create an environment more conducive to home-ownership. Properly designed, it can increase the productivity of workers, suggest an expansive showground for sportsmen, and provide a relaxed and open setting for shoppers. However, green space is not inexpensive. Premium turf grass, for example, is costly. Landscape trees are three to four times the cost of turf; and the cost of shrubbery, ornamentals, and landscape plants may exceed the cost of turf by tenfold. A facility may allocate a significant per acre monthly cost (e.g., in the thousands or tens of thousands of dollars per acre) for maintaining a premium landscape, with the cost of irrigation water consuming up to half of the maintenance budget.

As a consequence, during construction most facilities devote significant resources to the professional design and installation of irrigation systems, and most acquire reasonably state-of-the-art irrigation components. The objective is for the irrigation system to operate trouble-free for a number of years prior to re-evaluating the system and its components. The affirmation of these objectives is further reinforced by the unsurpassed reliability of many professional grade irrigation components. The life expectancy of professional grade electronic irrigation controllers and spray heads exceed ten years, excluding failures due to lightning or other damage. Even the more failure prone irrigation components, such as irrigation valves, regularly provide maintenance-free service for over five years.

The technology environment has rapidly developed allowing ever-increasing possibilities for irrigation control. Because irrigation controller systems have such long life expectancies, many currently installed systems lack the capabilities the current technological environment may have to offer. For example, some irrigation systems may not have the ability to locally generate an irrigation plan based on real-time sensor data, or the irrigation systems may have no wireless connectivity allowing for remote control, monitoring, or reporting. Given the high costs of installing a new irrigation control system, fully-equipped with modern technological capabilities, replacement may be prohibitively expensive.

Thus, there remains a need for improving irrigation controllers.

### SUMMARY

Embodiments of the present disclosure include systems, devices, and methods of interfacing with an irrigation controller.

In one general aspect, the present disclosure is directed to an irrigation controller interface device. The irrigation controller interface device includes a first communication interface configured to establish a first connection between the irrigation controller interface device and an irrigation controller. The irrigation controller interface device also includes a second communication interface configured to transmit and receive signals from a cellular data modem. The irrigation controller interface device also includes one or more processors operatively connected to the first communication interface and second communication interface. The one or more processors may be configured to: receive an instruction from the cellular data modem via the second communication interface, where the instruction indicates one or more zones of an irrigation system to control; generate a control signal to control the one or more zones based on the instruction; and cause the control signal to be transmitted via the first communication interface to the irrigation controller.

In some aspects, implementations may include one or more of the following features. The irrigation controller interface device where the first connection between the irrigation controller interface and the irrigation controller is established regardless of whether the irrigation controller comprises an existing wireless connectivity. The one or more processors are operatively connected to the second communication interface and further configured to: monitor current or power within a common wire of the irrigation controller; and transmit, via the second communication interface, status information based on the current or power within the common wire. The one or more processors further configured to: receive, via the third communication interface, sensor data from the one or more sensors. The one or more processors are further configured to: generate an irrigation plan based on the sensor data; identify one or more new zones based on the irrigation plan; and cause a new control signal to control the identified one or more new zones to be transmitted via the first communication interface to the irrigation controller. The one or more sensors may include a weather station, where the irrigation controller interface device receives the sensor data wirelessly from the weather station. The one or more processors are further configured to calibrate the control signal based on an electrical signal received from the irrigation controller.

In one general aspect, the present disclosure is directed to a method for irrigation control. The method includes receiving, at an irrigation controller interface device, power from an irrigation controller device in electrical communication with the irrigation controller interface device; receiving, at an irrigation controller interface device, an instruction from a cellular data modem; generate, at the irrigation controller interface device, irrigation instructions in a first format based on the instruction; generating, at the irrigation controller interface device, one or more messages in a second format based on the irrigation instructions in the first format, where the first format and second format are different. The method also includes transmitting, from the irrigation controller interface device, the one or more messages to the irrigation controller device, where the one or more messages cause the irrigation controller device to activate a plurality of first valves in accordance with the irrigation instructions; and monitoring, at the irrigation controller interface device, current or power within a common wire of the irrigation controller device.

In some aspects, implementations may include one or more of the following features. The method may include transmitting, from the irrigation controller interface device, status information about the plurality of first valves or the irrigation controller device. The method may include receiving, at the irrigation controller interface device, sensor data from a sensor in communication with the irrigation controller interface device. The one or more new messages cause the irrigation controller device to activate a plurality of second valves in accordance with the updated irrigation instructions. The sensor may include a weather station, where the weather station transmits the sensor data wirelessly to the irrigation controller interface device. The method may include calibrating, at the irrigation controller interface device, the one or more messages based on an electrical signal received from the irrigation controller device. The irrigation controller device may include a two-wire system.

In one general aspect, the present disclosure is directed to a non-transitory machine-readable medium that may include a plurality of machine-executable instructions which when executed by one or more processors, are adapted to cause the one or more processors to perform operations including: receive an irrigation instruction from a cellular data modem in a first format; generate one or more messages in a second format based on the irrigation instruction in the first format, where the first format and second format are different. The non-transitory machine-readable medium also includes output the one or more messages to the irrigation controller device, where the one or more messages cause the irrigation controller device to activate a plurality of first valves in accordance with the irrigation instructions and monitor current or power within a common wire of the irrigation controller device.

In some aspects, implementations may include one or more of the following features. The operations may include output status information about the plurality of first valves or the irrigation controller device. The operations may include receive sensor data from a sensor in communication with the irrigation controller interface device. The one or more new messages cause the irrigation controller device to activate a plurality of second valves in accordance with the updated irrigation instructions. The sensor may include a weather station, where the weather station transmits the sensor data wirelessly to an irrigation controller interface device. The operations may include calibrate the one or more messages based on an electrical signal received from the irrigation controller device.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a schematic, diagrammatic representation of a networked system for irrigation control, according to some aspects of the present disclosure.

FIG. 2 illustrates an irrigation control system, according to some aspects of the present disclosure.

FIG. 3 illustrates an irrigation controller and a controller interface device, according to some aspects of the present disclosure.

FIG. 4 is a simplified diagram illustrating a computing device implementing the controller interface device described in FIGS. 1-3, according to some aspects of the present disclosure.

FIG. 5 is an example logic flow diagram illustrating a method of irrigation control implemented by the systems and/or devices shown in FIGS. 1-3, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Exemplary embodiments of an irrigation controller interface device are presented herein. Irrigation controller interface devices described herein may connect to an installed base of pre-existing irrigation controller systems to provide additional capability to these pre-existing systems. The installed base of pre-existing irrigation controller systems may represent legacy devices and systems installed at considerable expense, and the irrigation controller interface devices described herein may provide additional capability to these legacy systems at a reasonable incremental cost. Irrigation controller interface devices described herein may provide ways to connect other devices and sensors that allow remote monitoring and control of the legacy irrigation controller devices and systems. In addition, an irrigation controller interface device may generate irrigation plans locally on the device based on sensor data received through various means from different sensors in the environment of the irrigation system. An irrigation controller interface device may also monitor and calibrate signals sent to or received from an existing controller for optimizing performance of the irrigation system.

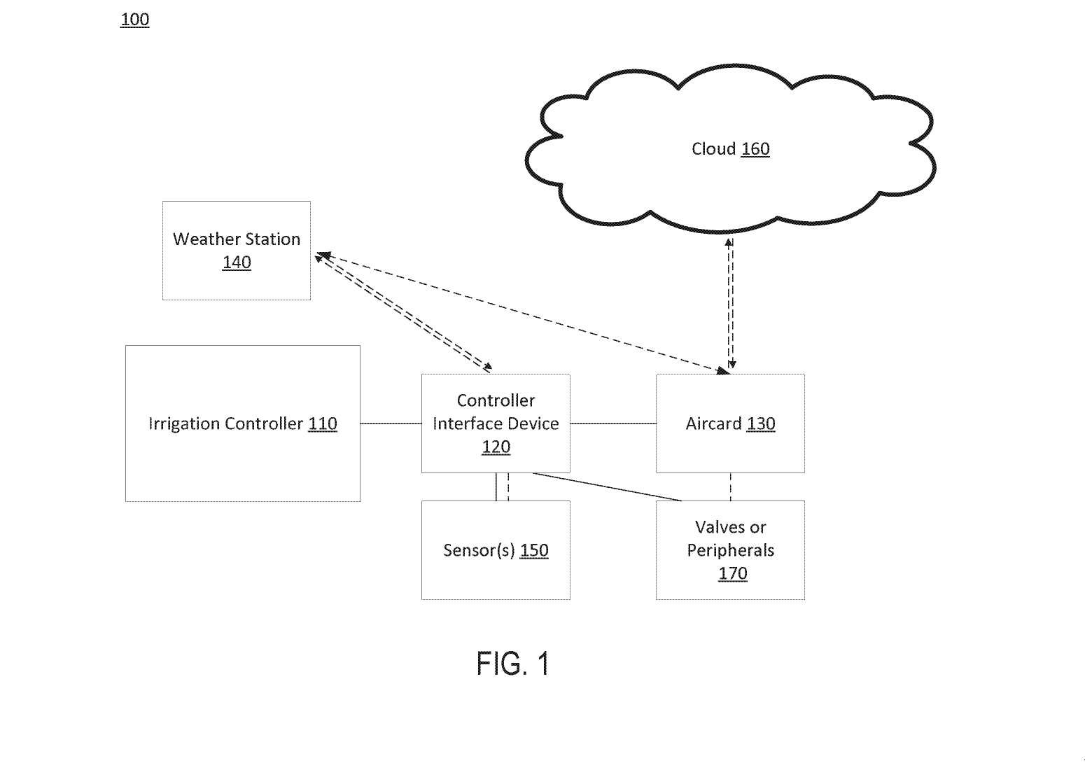

FIG. 1 is a schematic, diagrammatic representation of a networked irrigation control system 100, according to some aspects of the present disclosure. To facilitate the irrigation of a landscape, a networked irrigation control system 100 may implemented. The networked irrigation control system 100 may generate and/or implement an irrigation plan that ensures sufficient water and other resources are supplied to the landscape. In some aspects, an irrigation plan may be used to generate a number of instructions that activate one or more zones, (e.g., valves) of the irrigation system to water the corresponding zone. The networked irrigation control system 100 may include an irrigation controller 110, controller interface device 120, aircard 130, weather station 140, and sensor(s) 150. In some aspects, one or more of the components of the networked irrigation control system 100 may be in communication with a cloud computing system or service 160.

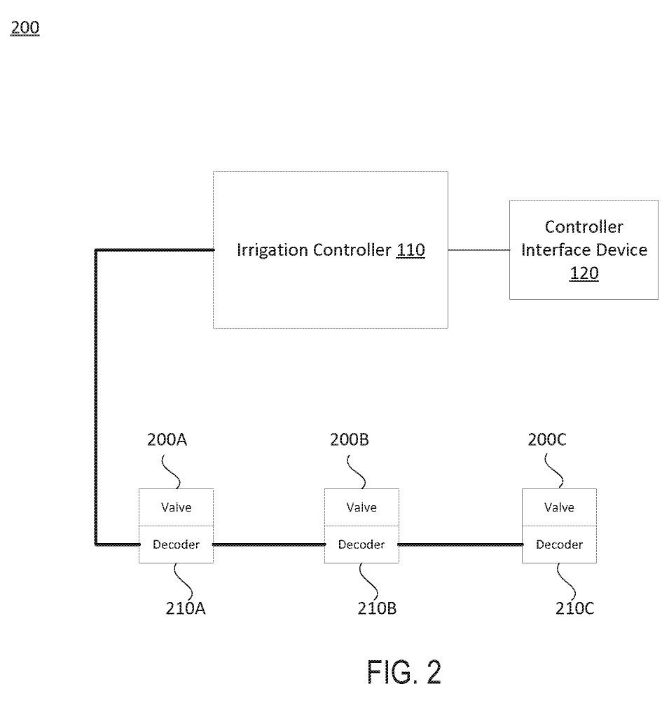

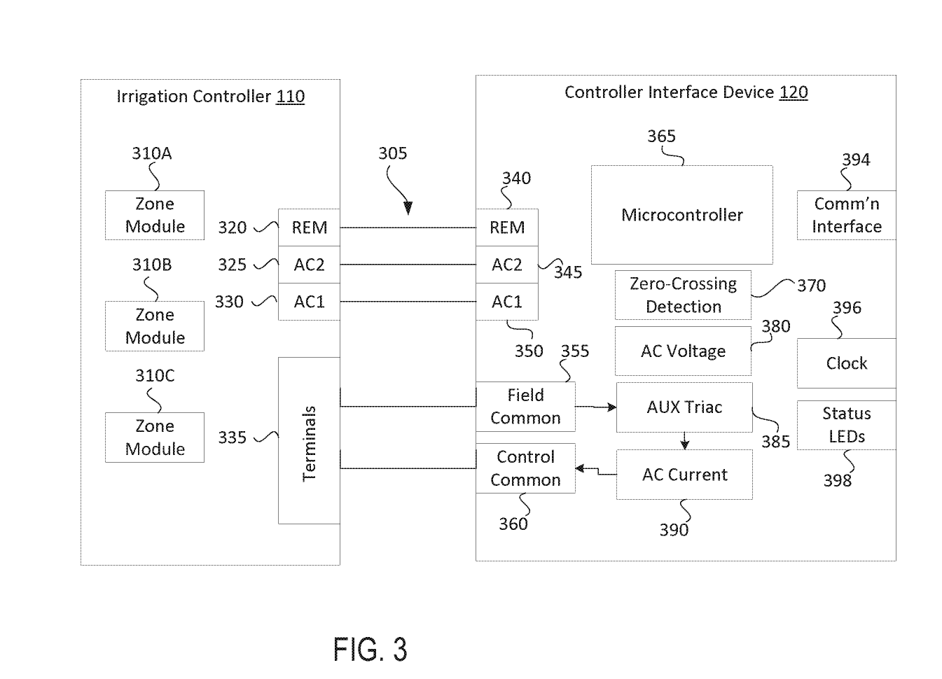

Irrigation controller 110 may control the irrigation of a landscape through one or more zones. Each zone may include one or more sprinkler heads and associated mechanical and electrical components to activate the sprinkler heads. Irrigation controller 110 may be connected to a controller interface device 120. The irrigation controller 110 may receive, e.g., over a wired connection with the controller interface device 120, one or more messages in a format conforming to the protocol of the irrigation controller 110 instructing the irrigation controller 110 to activate one or more zones and/or sprinkler heads of an irrigation system. In some aspects, irrigation controller 110 may be a single wire or two-wire system, where a single wire system includes a separate wire for each zone to control the zone and a two-wire system includes two wires that connect to one or more zones in series. In some examples, irrigation controller 110 may be a Hunter ACC2 Controller, including models A2C-1200-M, A2C-1200-P, A2C-01200-PP, A2C-1200-SS, A2M-600, A2C-1200-SBKIT, etc. Irrigation controller 110 is further described with respect to FIGS. 2-3. The irrigation controller 110 may represent a pre-existing or legacy irrigation controller that has no wireless connectivity and that is typically controlled locally via dials or other control mechanisms on the face of the irrigation controller.

Controller interface device 120 may generate messages for the irrigation controller 110 based on an irrigation plan, including instructions. In some aspects, controller interface device 120 may locally determine (e.g., using computing equipment contained therein) an irrigation plan based on received inputs, such as sensor data, weather reports, etc. In some aspects, controller interface device 120 may receive an irrigation instruction from another device or computing system through aircard 130. The irrigation instruction be in a format following a protocol different from the protocol of the irrigation controller 110. When an irrigation plan or instruction is received directly from the aircard, the controller interface device 120 translates the irrigation instruction from a first format to a second format, (e.g., from the protocol of the aircard 130 to the protocol of the irrigation controller 110). In this way, controller interface device may be configured to communicate according to two or more distinct protocols. In some aspects, controller interface device 120 may be connected to irrigation controller 110, aircard 130, weather station 140, and/or sensor(s) 150. As used herein, a protocol is associated with a format for a message sent according to the protocol.

In some aspects, controller interface device 120 may be connected to an aircard 130. An aircard 130 may include a wireless communications modem, such as a cellular data modem, capable of communication with cloud computing systems or services 160. In some aspects, aircard 130, or other hardware with similar capabilities, may be incorporated into controller interface device 120 as a single device. The cellular data modem may be capable of implementing any cellular protocol, such as fifth generation (5G) cellular protocols, 4G protocols (which may sometimes be referred to as Long Term Evolution or LTE protocols), 3G protocols, etc. In some aspects, controller interface device may transmit status information about the irrigation controller and/or other components of the irrigation system to aircard 130. The aircard 130 may transmit the status information through cloud 160 to a user device, database, or other device. Status information may include information about power consumption, hardware performance, irrigation performance, electrical performance of various components of the irrigation system, etc. In some aspects, information transmitted to the aircard 130 may be in the form of an alert. The aircard 130 may be, as examples, any SmartLink® aircard. The aircard 130 may additionally or alternatively include any other type of communication capability, such as WiFi or Bluetooth.

In some aspects, controller interface device 120 may be connected to a weather station 140. Weather station 140 may include one or more sensors, including for temperature readings, rain readings, wind speed readings, etc. In some aspects, weather station 140 is connected wirelessly to controller interface device 120 for data communication. In some aspects, weather station 140 is connected by wire to controller interface device 120 for data communication.

In some aspects, controller interface device 120 may be connected (e.g., via a wired or wireless connection) to sensor(s) 150. Sensors may include temperature sensors, rain sensors, wind sensors, etc. Sensor(s) 150 may be connected to controller interface device 120 through one or more corresponding terminals. In some aspects, the weather station 140 may communicate externally (e.g., to and from the cloud computing system or service 160) via the aircard 130. However, in other embodiments, the controller interface device 120 may support radio frequency (RF) wireless communications. In one example, the controller interface device 120 and the aircard 130 may be combined into a single device. The controller interface device 120 and/or aircard 130 may also communicate (e.g., through a wired or wireless connection) with valves or other peripherals 170. Peripherals may for example include lighting controllers, pump controllers, flow meters, current sensors, soil moisture sensors, humidity sensors, rain sensors, tamper sensors, audible alarms, remote display and supervisory control devices and user interfaces, and weather stations including barometers anemometers, etc.

FIG. 2 illustrates an irrigation control system 200, according to some aspects of the present disclosure. As described in FIG. 1, an irrigation controller 110 may be connected to controller interface device 120. Instructions provided by the controller interface device 120 to the irrigation controller 110, may be used by the controller to actuate one or more of the valves 200A-C. In some aspects, the irrigation control system 200 may include controller interface device 120, valves 200A-C, and decoders 210A-C.

Upon receiving one or more messages from the controller interface device 120, irrigation controller 110 may generate a signal containing one or more addresses associated with the valves that should be activated according to an irrigation plan. For example, each of the decoders 210A-C may be associated with a unique address. When the decoders 210A-C detect their respective address, then they cause the associated valves 200A-C to actuate, beginning irrigation of the area determined by the irrigation plan. In some examples, the one or more messages received by the irrigation controller 110 may conform to the Hunter ROAM protocol when the irrigation controller 110 is a Hunter controller.

Decoders 210A-C are used to decode signals sent by the irrigation controller 110, e.g., signals sent in response to the messages received at the irrigation controller 110 from controller interface device 120. Each decoder valve pair has a unique address such that each can be activated by a signal from the irrigation controller when it is sent with the correct address. If a decoder detects a signal with its address, then it will cause the valve to actuate and a sprinkler head to begin watering the nearby landscape.

In some aspects, each decoder 210A-C and valve 200A-C may control the operation of any number of sprinkler heads. For example, actuating valve 200A may cause 1,2, 3, 4, …, 50 sprinkler heads. In some aspects, each valve 200A-C is an electromechanical device including a solenoid that, when current passes through the solenoid, opens or closes a valve to allow or restrict the flow of water.

While FIG. 2 depicts a two-wire irrigation control system 200, in some aspects, a single wire irrigation control system may be controlled in a similar manner. In a single wire system, a separate wire may electrically connect the irrigation controller 110 and the decoders 210A-C and valves 200A-C. In a single wire system, one or more messages from the controller interface device 120 may cause the irrigation controller to send signals down one or more of the wires associated with each valve according to an irrigation plan.

FIG. 3 illustrates an irrigation controller 110 connected to a controller interface device 120, according to some aspects of the present disclosure. Irrigation controller 110 may be connected to a controller interface device 120 by one or more wires 305. Wires 305 may facilitate electrical communication between the irrigation controller 100 and the controller interface device 120 through various terminals and/or ports. In some aspects, the terminals described herein may also be referred to as communication interfaces.

Irrigation controller 110 may include one or more zone modules 310A-C. In some aspects, each zone module 310A-C may be associated with an address for a valve (e.g., valves 200A-C, such that zone module 310A is associated with valve 200A, zone module 310B is associated with valve 200B, and zone module 310C is associated with valve 200C. In some aspects, irrigation control 110 may include more or less than three zone modules. In some aspects, irrigation controller 110 may be a single wire controller, i.e., one wire connecting to each zone, or a two-wire controller, i.e. two-wires that connect to one or more zones in series.

In some aspects, irrigation controller 110 may include terminals 335 connected to the two wires of a two-wire system or single wires of a single wire system, which connect to the zones in the landscape depending on whether irrigation controller 110 is configured for two-wire connection or single-wire connection. Irrigation controller 110 may include first and second power terminals 325, 330, comprising a port capable of transmitting power to a controller interface device 120. The first and second power terminals 325, 330 may serve as a power source for the controller interface device 120 once the controller interface device 120 is connected to the irrigation controller 110. Irrigation controller 110 may include a remote terminal 320 for remote control by a remote. For example, Hunter ACC2 controllers may be connected to an associated Hunter remote, where the Hunter controller configured to receive a user input selecting zones for activation through the Hunter remote.

In some aspects, controller interface device 120 may include first and second respective power terminals 345, 350, configured to connect to power terminals 325, 330 of the irrigation controller 110. When power terminals 325, 330 are connected to respective power terminals 345, 350, the irrigation controller provides a power source of AC voltage 380 for the controller interface device 120. For example, the AC Voltage 380 received at the controller interface device may be 24V.

In some aspects, controller interface device 120 may include a field common terminal 355 and control common terminal 360 configured to allow controller interface device 120 the ability to monitor control signals sent by the irrigation controller 110. Controller interface device 120 may sense current output by the irrigation controller 110 through wires connecting the field common terminal 355 and control common terminal 360 to terminals 335. In some aspects, zero-crossing detection 370 is used to analyze current signals from the irrigation controller 110. In some aspects, microcontroller 365 may monitor and analyze the current signals from the irrigation controller 110. In response to detected current signals through terminals 355 and 360 microprocessor may cause a reporting message to be transmitted to the aircard 130 using the communication interface 394. The AUX Triac 385 may be used to enable or disable the field-common wiring from the solenoids contained in the valves of the irrigation system. AC current 390 is continuously measured and may cut off power to the field wiring in the event of an overcurrent situation. Full-wave current may be monitored to detect an imbalance of the positive and negative half-wave current, and derate and/or cut off power accordingly.

In some aspects, controller interface device includes a respective remote terminal 340 configured to allow the controller interface device 120 to send one or more messages to irrigation controller 110. Microcontroller 365 may receive or generate an irrigation plan. Microcontroller 365 may use one or more machine learning models stored locally on controller interface device (e.g., in memory) to determine an irrigation plan. Based on the irrigation plan, microcontroller 365 may generate one or more messages to be sent to the irrigation controller 110 through the connection between remote terminals 320, 340 in the native format of the irrigation controller 110. In some aspects, the one or more messages instruct the irrigation controller 110 to actuate the valves of one or more selected zones. In some aspects, the controller interface device 120 does not know the addresses of the decoders and valves (e.g., 200A-C and 210A-C) but is able to leverage the irrigation controller’s knowledge of those addresses to cause the valves to be actuated and irrigation to begin in one or more zones.

In some aspects, controller interface device 120 may include a clock 396. For example, clock 396 may be a real time clock including a CR2032 battery. In some aspects, controller interface device 120 may include status LEDs 398. For example, one color of LED (e.g., green) may indicate the device is on and another color of LED (e.g., red) may indicate the LED is off. Status LEDs 398 may allow a user to visually inspect the controller interface device to determine a status, such a power status (on/off) or an error status. In some aspects, controller interface device 120 may include a communication interface 394 to facilitate communication with aircard 130. For example, communication interface 394 may be a mating receiver to receive an RJ 6P4C jack, i.e., a standard telephone jack. As another example, communication interface 394 may be a transceiver capable of wirelessly transmitting and received signals from aircard 130, e.g., using radio signals such as implemented Bluetooth or other wireless technology standards. In some aspects, communication interface 394 may include a UART peripheral oscillator than divides standard 9600 and 115200 baud rates with less than 500ppm error. Though FIG. 3 depicts only a single communication interface, two or more communication interfaces may be included in the controller interface device 120. In some aspects, communication interface 394 may also power aircard 130 when connected.

In some aspects, microcontroller 365 may carry out one or more of the operations described above with respect to the controller interface device 120. For example, microcontroller 365 may monitor signals sent by the irrigation controller, power delivered from the irrigation controller, send signals to an aircard, receive time from clock 396 to time when one or more messages are sent to irrigation controller 110, control which status LED 398 is displayed, etc.

In some aspects, the irrigation controller 110 and the controller interface device 120 operate according to different protocols, where neither device’s protocol is capable of controlling the operation of the other. Thus, controller interface device is configured to generate one or more messages to send to the irrigation controller 110 in the protocol employed in the irrigation controller 110. The controller interface device 120 sends zone and duration information to the irrigation controller 110’s signaling protocol. For example, duration information may include one or more time intervals for irrigation to occur in one or more zones. In addition, during information may include one or more start or stop times for irrigation.

In some aspects, controller interface device 120 includes circuitry for an AC-to-DC converter to generate one or more DC sources of various voltages. For example, circuitry may generate one or more DC sources, including 3.3V and 5V, through other voltages may be generated. In some aspects, a DC source may be used to modify the signal levels of the one or more messages sent to an irrigation controller 110. In some aspects, a DC source may be used to power one or more components of the controller interface device 120 or components connected thereto (such as sensor(s) 150, aircard 130, etc.).

In some aspects, the controller interface device 120 could intercept the irrigation controller's control of its zones, directly. For example, instead of accessing a remote control interface, the controller interface device 120 may replace or intercept the control of the zones between the control panel and the zone output driver system. This may for example be done with a Rainbird 2-wire controller, because the Rainbird remote interface only allows for a single zone to operate at a time, whereas the controller interface device 120 of the present disclosure can control many more zones. Such control over multiple zones may for example be accomplished by directly accessing each zone’s encoder, by connecting between its front panel and its chassis printed circuit board assembly (PCBA). Alternatively, a user could replace or disconnect their entire irrigation control system, and drive its irrigation devices with the controller interface device 120.

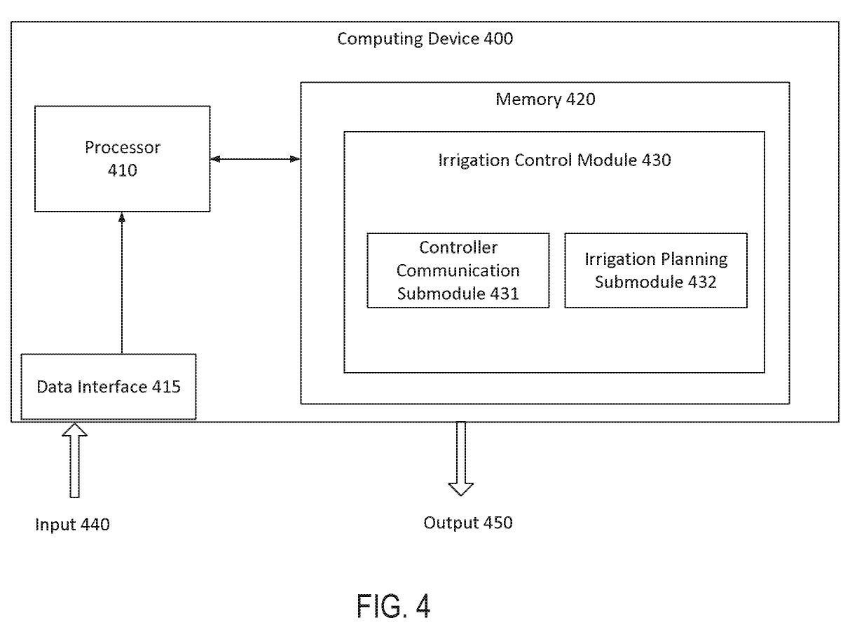

FIG. 4 is a simplified diagram illustrating a computing device implementing the controller interface device 120 described in FIGS. 1-3, according to some aspects of the present disclosure. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities. In some aspects, processor 410 may be included in microcontroller 365 described in FIG. 3.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for irrigation control module 430 that may be used to implement and/or emulate the systems and models, and/or to implement any of the methods described further herein. Irrigation control module 430 may receive input 440 such as irrigation instructions (e.g., schedules for activating different zones in an irrigation control system) via the data interface 415 and generate an output 450 which may be one or more messages (e.g., messages sent to irrigation controller 110 in the format following the protocol used by the irrigation controller) implementing the irrigation instructions.

The data interface 415 may include a communication interface. For example, the computing device 400 may receive the input 440 (sensors data from sensor(s) 150, instructions from aircard 130, current signals generated by irrigation controller 110) via a respective communication interface. Inputs (e.g., sensors data from sensor(s) 150, instructions from aircard 130, current signals generated by irrigation controller 110) may be received via a data interface such as data interface 415 or via a data interface that is integrated with a device. In some aspects, user instructions computed from a user device may be communicated to the computing device 400 via the aircard 130. Data interface may include one or more interface of varying types as described herein. In some aspects, outputs 450 may also be transmitted through data interface 415. For example, output may include one or more messages sent to irrigation controller 110, reporting and monitoring information sent to aircard 130, etc.

In some embodiments, the irrigation control module 430 is configured to control the operation of an irrigation control system (e.g., 200 in FIG. 2). The irrigation control module 430 may further include controller communication submodule 431 (e.g., for generating the one or more messages in a second format sent to irrigation controller 110 from irrigation instructions in a first format). Controller communication submodule 431 may be configured to generating the one or more messages sent to irrigation controller 110. The irrigation control module 430 may further include irrigation planning submodule 432 (e.g., for determining an irrigation schedule and/or irrigation resource allocation based on any received input such as irrigation instructions, sensor data, or data from a weather station). Irrigation planning submodule 432 may be configured determine an irrigation schedule and/or irrigation resource allocation in accordance with received and/or sensed information.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

In some aspects, computing device 400 may further include one or more transceivers capable of sending and receive signals. For example, the transceivers may operate in the radio spectrum according to any of the associated standards governing the relevant section of the spectrum. A transceiver may include a single antenna for both transmitting and receiving or it may include a separate antenna for each of transmitting and receiving. For example, computing device 400 may receive at a transceiver weather information from a weather station 140. In some aspects, when aircard 130 is incorporated into the controller interface device 120, a transceiver may send and receive signals with a cell tower to place the controller interface device 120 in communication with the cloud 160.

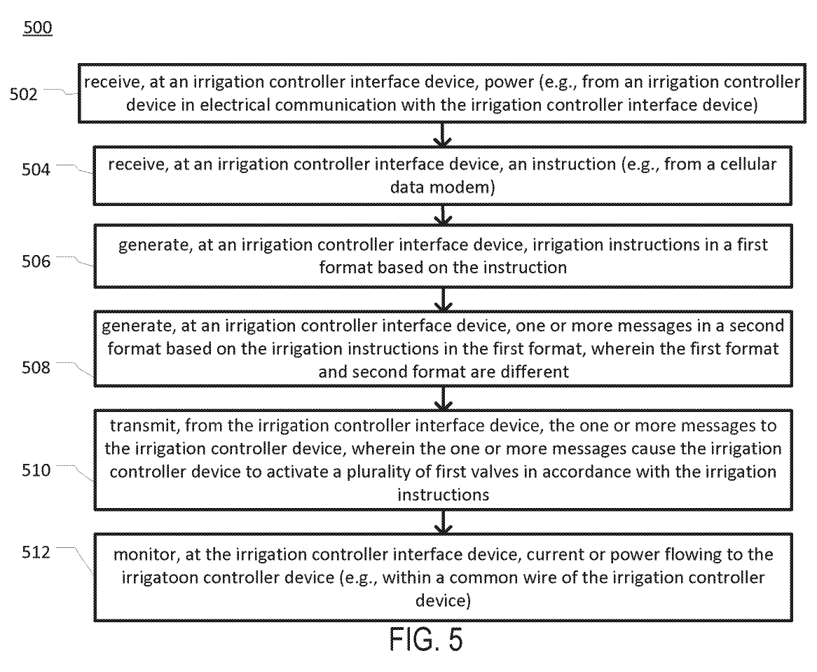

FIG. 5 is an example logic flow diagram illustrating a method of irrigation control implemented by the systems and/or devices shown in FIGS. 1-3, according to some aspects of the present disclosure. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the irrigation control module 430 that performs message generation for instructing an irrigation controller (e.g., irrigation controller 110 in FIGS. 1-3).

In some embodiments, method 500 is performed by a system such as computing device 400 (e.g., controller interface device 120) or another device or combination of devices. Inputs (e.g., sensors data from sensor(s) 150, instructions from aircard 130, current signals generated by irrigation controller 110) may be received via a data interface such as data interface 415 or via a data interface that is integrated with a device. Data interface 415 may include one or more interfaces of varying types as described herein. In some aspects, outputs 450 may also be transmitted through data interface 415. For example, output may include one or more messages sent to irrigation controller 110, reporting, monitoring, and/or status information sent to aircard 130, etc. In some aspects, the irrigation controller may be configured for a two-wire irrigation system or a single wire irrigation system.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, receive, at an irrigation controller interface device (e.g., controller interface device 120 in FIGS. 1-4), power from a power source. The power can be derived directly from the existing irrigation controller (e.g., irrigation controller 110 in FIGS. 1-3), but can also be supplied by other means, such as a separate wall adapter, a solar panel, a battery, a parasitic connection to another local device, or combinations thereof. In an example, the irrigation controller interface 120 receives power from an irrigation controller device (e.g., irrigation controller 110 in FIGS. 1-3) in electrical communication (e.g., through wire connecting first and second power terminals 325, 330 on the irrigation controller and first and second respective power terminals 345, 350 on the controller interface device 120 in FIG. 3) with the irrigation controller interface device. In some aspects, the irrigation controller interface device receives sensor data from a sensor (e.g., sensor(s) 150 in FIG. 1 or weather station 140) in communication with the irrigation controller interface device. In some aspects, sensor data from weather station 140 may be received wirelessly at the controller interface device.

At step 504, receive, at an irrigation controller interface device (e.g., controller interface device 120 in FIGS. 1-4), an instruction. The instruction could be received via RF telemetry communications, a wired fieldbus, or other means. In an example, the instruction is received from a cellular data modem (e.g., aircard 130 as in FIG. 1). In some aspects, the instruction may include an indication of a level of resource conservation to be utilized by the irrigation control system. For example, the indication may rank zones in the irrigation system according to their priority for receiving water resources, e.g., a putting green may be ranked higher than the wooded rough on a golf course. In some aspects, the controller interface device 120 may receive direct commands from aircard 130 and immediately execute those commands. For example, aircard 130 may instruct the controller interface device 120 to immediately open one or more valves for one or more zones. In some aspects, controller interface device 120 may receive scheduling information, e.g., zone and duration information, from aircard 130, and operate autonomously. For example, controller interface device 120 may account for rainfall amounts on one or more zones when controlling irrigation according to the scheduling information (i.e., controller interface device 120 may reduce the amount of watering through the irrigation system after it has rained on the irrigated landscape).

At step 506, generate, at an irrigation controller interface device (e.g., controller interface device 120 in FIGS. 1-4), irrigation instructions in a first format based on the instruction. The irrigation controller 110 may generate, e.g., using processor 410, an irrigation plan which includes irrigation instructions to be sent to the irrigation controller 110. In some aspects, one or more zones (e.g., valves 200A-200C associated with one or more zones in FIG. 2) of an irrigation control system (e.g., 200 in FIG. 2) may be identified based on an irrigation plan.

At step 508, generate, at an irrigation controller interface device, one or more messages in a second format based on the irrigation instructions in the first format, wherein the first format and second format are different. For example, as described herein, the controller interface device 120 and irrigation controller 110 may operate according to different protocols, e.g., they transmit/receive instructions in different formats. Thus, the controller interface device 120 translates the generated irrigation instructions into the format of the irrigation controller 110. In some aspects, controller interface device 120 may operate autonomously according to received scheduling information, e.g., zone and duration information, from aircard 130. For example, controller interface device 120 may generate one or more messages minutes, hours, days, or weeks after receiving scheduling information from aircard 130. In this way, the controller interface device 120 operates autonomously within the bounds of the scheduling information received from the aircard 130 in the past.

At step 510, transmit (e.g., over the wire connecting remote terminals 320, 340), from the irrigation controller interface device (e.g., controller interface device 120 in FIGS. 1-4), the one or more messages to the irrigation controller device (e.g., irrigation controller 110 in FIGS. 1-3), wherein the one or more messages cause the irrigation controller device to activate a plurality of first valves (e.g., valves 200A-C in FIG. 2) in accordance with the irrigation instructions. In some aspects, the one or more messages are transmitted as a control signal to the irrigation controller. In some aspects, the irrigation controller interface device may detect the signals output by the irrigation controller in response to the one or more messages. For example, using the wire connecting the control common terminals.

At step 512, monitor (e.g., through field common terminal 355 or control common terminal 360), at the irrigation controller interface device (e.g., controller interface device 120 in FIGS. 1-4), current or power within a common wire of the irrigation controller device (e.g., irrigation controller 110 in FIGS. 1-3). In some aspects, current may be monitored by other means, such as a Hall effect sensor. In some aspects, the irrigation controller interface device may transmit status information about the plurality of first valves or the irrigation controller device to the air card 130. In some aspects, usage (e.g., water usage) and sensor data (e.g., from weather station 140 and/or sensor(s) 150) may be transmitted to aircard 130. For example, status information may be determined by monitoring the current, i.e., an electrical signal, in the field common wire connected to the associated field common terminal 355. In response to the status information, the controller interface device may calibrate or otherwise modify the signal used to transmit the one or more messages, e.g., by applying a DC voltage to the output signal for the one or more messages to lower or raise the voltage of the signal. For example, the controller may determine to shutdown zones and/or disconnect power (e.g., via common) upon an overcurrent, undercurrent event, etc. In some aspects, the controller can also determine if valves are powered as a feedback to ensure operation or non operation.

In some aspects, one or more of the steps above may be repeated iteratively as new sensor data or other information is receive at the controller interface device 120. For example, the irrigation controller interface device may update (or generate new) the irrigation instructions based on the sensor data from sensors 150 or weather station, then generate one or more new messages based on the updated irrigation instructions, and then transmit the one or more new messages to the irrigation controller device, wherein the one or more new messages cause the irrigation controller device to activate a plurality of second valves (e.g., one or more of valves 200A-C different from those actuated by the previous instructions) in accordance with the updated irrigation instructions.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. An irrigation controller interface device comprising:
a first communication interface configured to establish a first connection between the irrigation controller interface device and an irrigation controller;
a second communication interface configured to transmit and receive signals from a cellular data modem; and
one or more processors operatively connected to the first communication interface and second communication interface, configured to:
receive an instruction from the cellular data modem via the second communication interface, wherein the instruction indicates one or more zones of an irrigation system to control;
generate a control signal to control the one or more zones based on the instruction; and
cause the control signal to be transmitted via the first communication interface to the irrigation controller.

2. The irrigation controller interface device of claim 1, wherein the first connection between the irrigation controller interface and the irrigation controller is established regardless of whether the irrigation controller comprises an existing wireless connectivity.

3. The irrigation controller interface device of claim 1, comprising:
wherein the one or more processors are operatively connected to the second communication interface and further configured to:
monitor current or power within a common wire of the irrigation controller; and
transmit, via the second communication interface, status information based on the current or power within the common wire.

4. The irrigation controller interface device of claim 1, comprising:
a third communication interface configured to receive signals from one or more sensors,
wherein the one or more processors further configured to:
receive, via the third communication interface, sensor data from the one or more sensors.

5. The irrigation controller interface device of claim 4, wherein the one or more processors are further configured to:
generate an irrigation plan based on the sensor data;
identify one or more new zones based on the irrigation plan; and
cause a new control signal to control the identified one or more new zones to be transmitted via the first communication interface to the irrigation controller.

6. The irrigation controller interface device of claim 4, wherein the one or more sensors comprise a weather station, wherein the irrigation controller interface device receives the sensor data wirelessly from the weather station.

7. The irrigation controller interface device of claim 1, wherein the one or more processors are further configured to:
calibrate the control signal based on an electrical signal received from the irrigation controller.

8. A method for irrigation control comprising:
receiving, at an irrigation controller interface device, power from an irrigation controller device in electrical communication with the irrigation controller interface device;
receiving, at an irrigation controller interface device, an instruction from a cellular data modem;
generate, at the irrigation controller interface device, irrigation instructions in a first format based on the instruction;
generating, at the irrigation controller interface device, one or more messages in a second format based on the irrigation instructions in the first format, wherein the first format and second format are different;
transmitting, from the irrigation controller interface device, the one or more messages to the irrigation controller device, wherein the one or more messages cause the irrigation controller device to activate a plurality of first valves in accordance with the irrigation instructions; and
monitoring, at the irrigation controller interface device, current or power within a common wire of the irrigation controller device.

9. The method of claim 8, further comprising:
transmitting, from the irrigation controller interface device, status information about the plurality of first valves or the irrigation controller device.

10. The method of claim 8, further comprising:
receiving, at the irrigation controller interface device, sensor data from a sensor in communication with the irrigation controller interface device.

11. The method of claim 10, further comprising:
updating, at the irrigation controller interface device, the irrigation instructions based on the sensor data;
generating one or more new messages based on the updated irrigation instructions; and
transmitting, from the irrigation controller interface device, the one or more new messages to the irrigation controller device, wherein the one or more new messages cause the irrigation controller device to activate a plurality of second valves in accordance with the updated irrigation instructions.

12. The method of claim 10, wherein the sensor comprises a weather station, wherein the weather station transmits the sensor data wirelessly to the irrigation controller interface device.

13. The method of claim 8, further comprising:
calibrating, at the irrigation controller interface device, the one or more messages based on an electrical signal received from the irrigation controller device.

14. The method of claim 8, wherein the irrigation controller device comprises a two-wire system.

15. A non-transitory machine-readable medium comprising a plurality of machine-executable instructions which, when executed by one or more processors, are adapted to cause the one or more processors to perform operations comprising:
receive an irrigation instruction from a cellular data modem in a first format;
generate one or more messages in a second format based on the irrigation instruction in the first format, wherein the first format and second format are different;
output the one or more messages to an irrigation controller device, wherein the one or more messages cause the irrigation controller device to activate a plurality of first valves in accordance with the irrigation instructions; and
monitor current or power within a common wire of the irrigation controller device.

16. The non-transitory machine-readable medium of claim 15, the operations further comprising:
output status information about the plurality of first valves or the irrigation controller device.

17. The non-transitory machine-readable medium of claim 15, the operations further comprising:
receive sensor data from a sensor in communication with an irrigation controller interface device.

18. The non-transitory machine-readable medium of claim 17, the operations further comprising:
update the irrigation instructions based on the sensor data;
generate one or more new messages based on the updated irrigation instructions; and
output the one or more new messages to an irrigation controller device, wherein the one or more new messages cause the irrigation controller device to activate a plurality of second valves in accordance with the updated irrigation instructions.

19. The non-transitory machine-readable medium of claim 17, wherein the sensor comprises a weather station, wherein the weather station transmits the sensor data wirelessly to an irrigation controller interface device.

20. The non-transitory machine-readable medium of claim 15, the operations further comprising:
calibrate the one or more messages based on an electrical signal received from the irrigation controller device.
